(19) United States
(12) Patent Application Publication
(10) Pub. No.: US 2015/0339712 A1
(43) Pub. Date: Nov. 26, 2015

(54) Inferring Facts from Online User Activity

(71) Applicant: HEWLETT-PACKARD DEVELOPMENT COMPANY, L.P., Houston, TX (US)

(72) Inventors: GEORGIA KOUTRIKA, PALO ALTO, CA (US); JERRY J. LIU, PALO ALTO, CA (US)

(21) Appl. No.: 14/758,739

(22) PCT Filed: Jan. 3, 2013
(86) PCT No.: PCT/US13/20099

§ 371 Date: Jun. 30, 2015

(51) Int. Cl. G06Q 30/02; G06N 5/04

(52) U.S. Cl. CPC G06Q 30/0255; G06N 5/048

(57) ABSTRACT

Inferring facts from online user activity includes performing an analysis of a uniform resource locator of a web page in response to predetermined user activity, mapping data about the web page to a structured object based on the analysis, and inferring a fact about the user activity based on the mapped data.

### BACKGROUND

Online advertising programs include mechanisms for customizing advertisements targeted to specific online users. Such programs consider the different web pages that an online user clicks through and analyze those web pages collectively to understand the user's search intent. If a pattern is recognized through this click analysis, the programs adjust their advertisements to be more in-line with what the program perceives to be the user's intent.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a network according to principles described herein.

FIG. 2 is a diagram of an example of a flowchart of a process for inferring facts from online user activity according to principles described herein.

FIG. 3 is a diagram of an example of populating a uniform resource locator object according to principles described herein.

FIG. 4 is a diagram of an example of populating a web page content object according to principles described herein.

FIG. 5 is a diagram of an example of consulting external resources according to principles described herein.

FIG. 6 is a diagram of an example of inferring facts according to principles described herein.

FIG. 7 is a diagram of an example of a display according to principles described herein.

FIG. 8 is a diagram of an example of a method for inferring facts from online user activity according to principles described herein.

FIG. 9 is a diagram of an example of a system for inferring facts from online user activity according to principles described herein.

FIG. 10 is a diagram of an example of an inference system according to principles described herein.

FIG. 11 is a diagram of an example of a flowchart of a process for inferring facts from online user activity according to principles described herein.

### DETAILED DESCRIPTION

While online advertisement targeting programs consider all the user's clicks globally, not all clicks made by an online user are relevant to determining the user's intent. For example, a user may click on a web page and determine that the web page is irrelevant to what the user is seeking. Such an irrelevant web page is not useful for determining the advertisements with which to target the online user. However, these irrelevant web pages are included in the program's calculation for determining the user's intent.

The principles described herein consider predetermined types of user activity to infer facts about the user. Such facts can be used to target advertisements, customize online recommendations, automatically fill in user profiles, or other activities that utilize the inferred facts. Such principles consider each of the web pages separately where the user seeks to retain the web page's content. Retaining the web page's content signifies a higher probability that the web page in question is relevant to the user's search and may reveal personal facts about the user. Such facts can be utilized to customize the user's web experience.

The principles described herein include a method for inferring facts from online user activity. Such a method includes performing an analysis of a uniform resource locator of a web page in response to predetermined user activity, mapping data about the web page to a structured object based on the analysis, and inferring a fact about the user based on the mapped data. The user fact may include recently performed user online activities, user interests, user status, other user facts, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

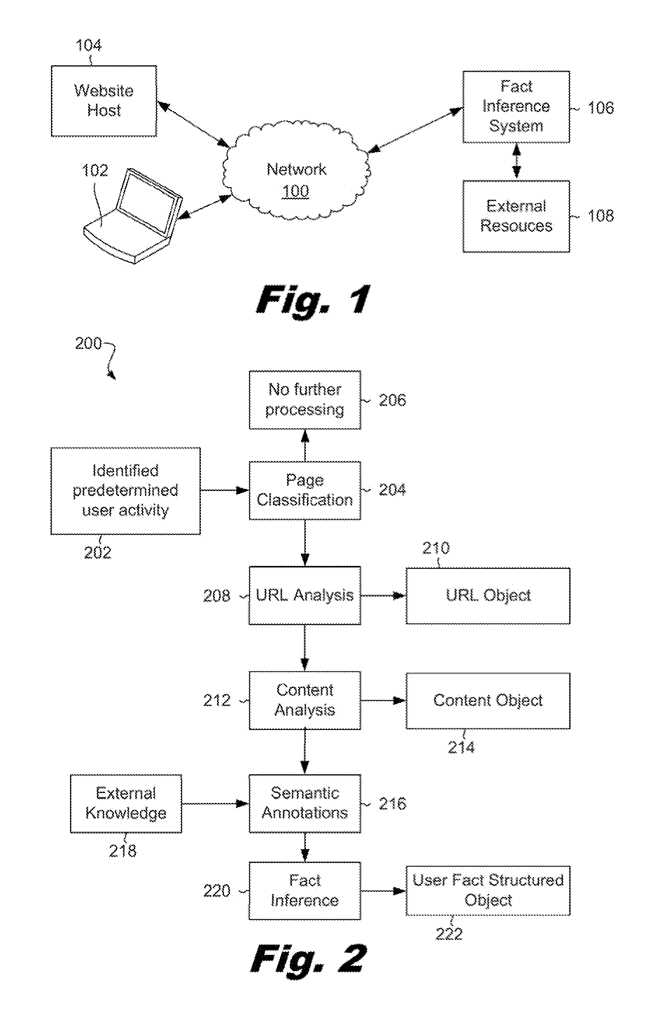

FIG. 1 is a diagram of an example of a network (100) according to principles described herein. In this example, a user interface (102) is connected to the network (100). The user interface (102) may be a personal computer, a desktop, a laptop, an electronic tablet, a phone, a personal digital device, a printer, a watch, another user interface capable of accessing the internet, or combinations thereof. A user can access web pages through the user interface's connection to the network (100). A website host (104) hosts at least one website that the user can view.

A fact inference system (106) is in communication with the user interface (102) over the network (100). However, in other examples, the fact inference system (106) is in communication with the user interface (102) or incorporated directly into the user interface (102). The fact inference system (106) tracks the user's activity online. If the fact inference system (106) determines that the user has performed a predetermined user activity, the fact inference system (106) will analyze the web page where the user performed the predetermined user activity. The predetermined user activity includes activities where the user retained at least a portion of the web page's content. For example, the user retains at least a portion of the web page's content when the user prints, saves, copies, bookmarks, clips, or otherwise retains the web page's content.

Retaining at least a portion of the web page's content signifies that the web page's content is relevant to the user's online intent. Further, retaining information from a web page can reveal facts about the user. For example, when a user copies a cooking recipe for seafood, there is a much higher probability that the user is interested in seafood than when the user merely clicks on a web page that contains a seafood recipe. Further, if the user prints a web page that contains information about a booked flight, the web page reveals the user's geographic location and a travel location to which the user likely has some connection. Inferred facts from the user's online activity may also reveal a user's interests, age, gender, marital status, occupation, education level, hobbies, skills, other useful information, or combinations thereof about the user which can be utilized by advertisement matching programs, online recommendation programs, online profile programs, other programs, or combinations thereof.

The fact inference system (106) infers facts from the web page by analyzing the web page's uniform resource locator (URL) and the web page's content. The fact inference system (106) extracts all of the data from the web page that the fact inference system (106) determines to be relevant to deriving a meaningful fact about the user. For example, the fact inference system (106) may recognize meaningful information in the URL, such as keywords that describe the content of the web page. Country indicators, such as “.ru” or “.ua” in the URL may reveal the user's location. Further, domain names, such as “.gov” or “.edu” may also reveal information about the user. Keywords from the web page's content also reveal information about web page's content that allow a fact about the user to be inferred.

The fact inference system (106) may extract information that the fact inference system fails to initially understand when that data is extracted. In such a circumstance, the fact inference system (106) queries external resources (108), such as a database, to understand the meaning. For example, the fact inference system (106) may recognize that the web page has content referring to airport codes, but the fact inference system (106) may not know which airports are represented by the extracted codes. In such an example, the fact inference system (106) queries a database that contains information about airport codes to determine which airports are included in the web page's content. In some circumstances, the fact inference system may cause a web search to be conducted to determine the meaning of the extracted information. The external resources (108) may include databases, the internet, online resources, dictionaries, encyclopedias, directories, manuals, calendars, catalogs, blogs, indexes, statistical models, other sources of information, or combinations thereof. Further, the external resources may include a learning mechanism that uses a learning function that recognizes patterns in extracted information over time, which allows the fact inference system to understand the meaning of future extracted information.

FIG. 2 is a diagram of an example of a flowchart (200) of a process for inferring facts from online user activity according to principles described herein. In this example, a predetermined user activity is identified (202) by an online user activity analyzer. The predetermined user activity may be a user initiated action that retains at least some of the information contained on a web page. Such predetermined activities may include printing, saving, clipping, copying, or bookmaking at least a portion of the web page's content.

In response to identifying the predetermined user activity, the process includes classifying (204) the web page type. The web page category types may include emails, private pages, commercial pages, public pages, website homepages, web pages with sensitive information, other types of pages, or combinations thereof. Some of the category types are cleared for further progressing while other category types trigger the end of the progress with no further processing (206). For example, email web pages and web pages with sensitive information may be excluded from processing. In this manner, the online user's personal information is protected.

If the web page is cleared for processing, the URL is analyzed (208) for meaningful information that could be the basis of an inferred fact. Such information is extracted from the URL, and an URL object (210), such as an electronic file, is populated with the meaningful information. The URL analysis is based on the observation that the URL often represents a textual summary of the actual content of the web page. This textual description is meaningful and human-readable so that an online user can memorize at least part of the URL and retype the URL in the appropriate field. It may also represent the site's structure and organization and the functionality of the particular web page. URL analysis is significant by itself since a web page analyzer may be able to extract useful information from just the URL because the web page's content is not accessible, not analyzable, or has expired. For example, if a user books a trip and prints his ticket, the analyzer can “read” the information in the URL, but may not be able to read the web page's actual content. In another example, web pages with images may not be analyzed as efficiently with certain content analysis methods.

The content of the web page is also analyzed (212). Meaningful information from the web page's content may include keywords, the frequency of the keywords, the position of the keywords in the web page's layout, image captions, meta tags, other content information, or combinations thereof. This information is extracted from the web page and used to populate a content object (214).

The extracted information in the URL object (210) and the content object (214) is given additional meaning through semantic annotation (216). Such annotations include attaching names, attributes, comments, descriptions, other meta data, or combinations thereof to the extracted information. Annotating the extracted information gives more meaning to unstructured or semi-structured data in a structured format. For those URL and content objects (210, 214) that already have some structure, semantic annotations can provide additional structure. The semantic annotations can tell computer programs the meaning of the extracted data and how the various extracted data relate to each other. An analyzer consults with external resources (218), such as databases, the internet, other information sources, or combinations thereof, to provide the meaning to the non-understood extracted data.

Based on the combination of the extracted data from the URL, the extracted data from the web page content, and the semantic annotations, the facts can be inferred (220) about the user. For example, by analyzing a URL that contains airport codes and dates, the final user fact may represent that the user has booked a trip and information about this trip. The annotated extracted data is inserted into a user fact structured object (222) that provides the inferred facts about the user. Additionally, the inferred facts can be used to infer other facts about the user. These facts may include the user's likes, interests, profession, and so forth. Also, the inferred facts can include online transactions performed by the user, such as booking a trip, joining an organization, participating in an online group discussion, determining a driving route between two locations, other activities, or combinations thereof.

A user fact is a structured object that contains meaningful information about the user based on the web page retained by the user. For example, if a web page has online games for kids, an inferred user fact can be that the user is a parent and has young kids. As a result, the inference mechanism is complex and involves more than just mapping information from the URL and content objects to another object that represents the fact. An inference engine figures out how clues from the combination of the extracted data from the URL, the extracted data from the web page content, and the semantic annotations define a certain type of user fact and how the components of the user fact will be populated. For example, the inference engine can be performed using rule engines, statistical models, other mechanism, or combinations thereof. As an example, the URL may be http://www.travel-destination-website.com/flights#/EWR-MIA/2012-09-04/2012-09-11. The gathered information after the URL analysis, content analysis, and semantic annotation may include {website: travel-destination-website, trip: flight, airportcode: EWR, airportcode: MIA, date; 2012-09-04, date; 2012-09-11}. In this example, the user fact can be constructed as the following: {type: TRIP, start date: 2012-09-04, end date: 2012-09-11, start location: EWR, start type: airport code, end location: MIA, end type: airport code, travel: flight}.

The inferred facts may be used in real time. For example, in response to the user printing off a seafood recipe from a web page, a program may immediately alter online advertising materials to be about cooking recipes, seafood, cooking ingredients, cooking hardware, other related items, or combinations thereof as the facts are inferred. On the other hand, the inferred facts may be utilized over time. For example, if the program infers that the user is frequently flying to Tampa, Fla. over other destinations, the program can include more advertisements to hotels, car rentals, restaurants, and other services that are located in Tampa, Fla.

FIG. 3 is a diagram of an example of populating a uniform resource locator (URL) object (300) according to principles described herein. In this example, a web page's URL (302) is https://destination-travel-website.com/book.php?BISESSID=1223de0927ae0e33&hotelVendorid=MV&tripType=package&locationId=BOS&fsId=&pt+hf&f=EWR&ptl=BOS&fd=2012-05-15&td=2012-05-21 &roomId=MANORQUEEN. An URL analysis engine (304) can extract potentially meaningful data from this URL.

For example, the name (306) of the website is destination-travel-website.com indicating that the website is about traveling. Further, immediately following the .com domain, the URL contains the action verb “book” suggesting that the web page has the ability to book (308) flights. Next, the group (309) of letters “BISESSID” appears to be a title of some kind of category, and the following code “1223de0927ae0e33” (310) appears to be an identification number. Also, “hotelVendorId” (312) appears to be a title of another category, and “MV” (314) appears to be an option within the hotelVendorId category (312). Next, “tripType” (316) appears to be another title of another category, and “package” (318) appears to be an option within the “tripType” category.

Further, “locationId” (320) appears to be another category name, and “BOS” (322) appears to be an option within the locationId category (320). Also, “fl” (324) appears to be a category name, and “EWR” (326) appears to be a category within the “fl” category. Next, “ptl” (326) appears to be a category name, and “BOS” (328) appears to be an option within the “ptl” category. Additionally, “fd” (330) appears to be a category name, and “2012-05-15” (332) appears to be an option within the “fd” category. Also, “td” (334) appears to be a category name, and “2012-05-21” (336) appears to be an option within the “td” category. Further, “roomId” (338) appears to be a category name, and “MANORQUEEN” (340) appears to be an option within the “roomId” category.

All of this data may be extracted into the URL object regardless of whether all, some, or even any of the information's meaning is understood. The URL object (300) may be formatted with as much structure as possible at this point. However, at a later phase, annotations can be added to non-understood data, which will allow for more structure and greater understanding.

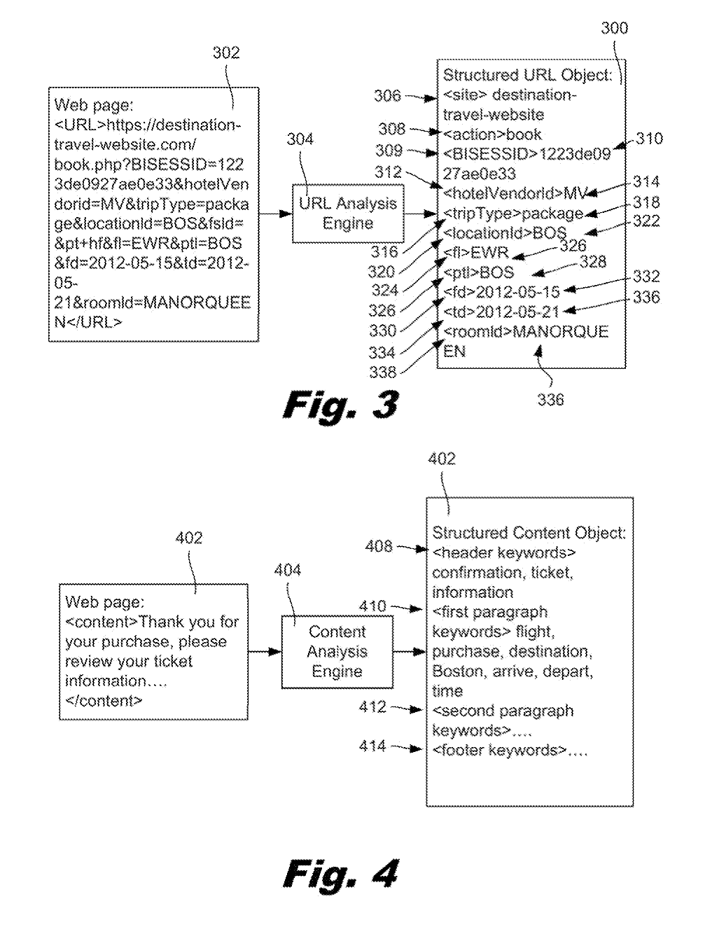

FIG. 4 is a diagram of an example of populating a web page content object (400) according to principles described herein. In this example, data from the content (402) of the web page is extracted with a content analysis engine (404) to the web page content object (400).

The content analysis engine (404) extracts keywords from the web page content (402) and may organize the keywords by paragraph, headers, footers, image captions, or with a different organizational structure. In the example of FIG. 4, the keywords (406) are organized by header (408), first paragraph (410), second paragraph (412), footer (414), and so forth. The content object (400) may also include keyword frequency, keyword position, other information extracted from the web page's content, or combinations thereof.

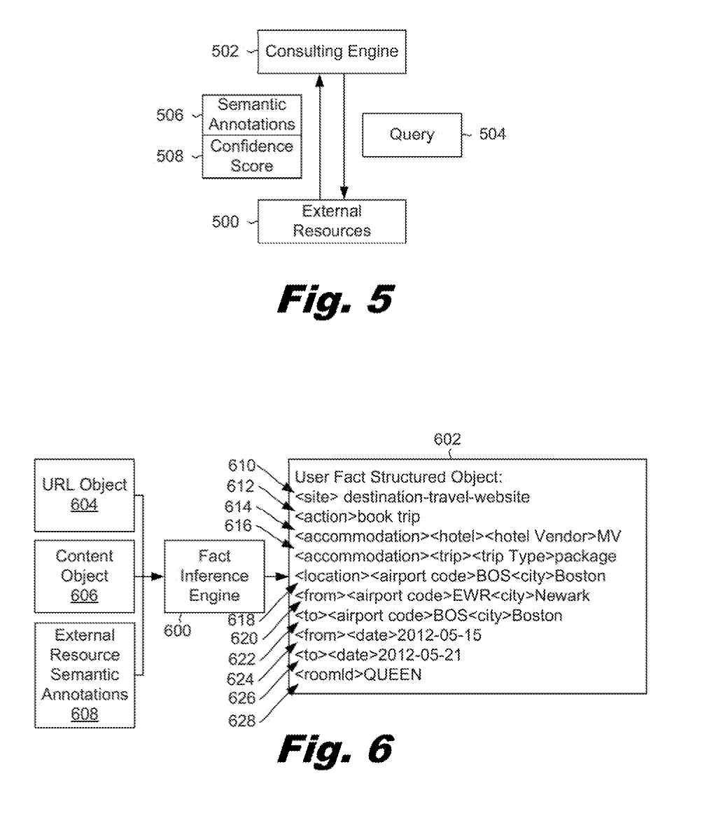

FIG. 5 is a diagram of an example of consulting external resources (500) according to principles described herein. In this example, a consulting engine (502) recognizes when extracted data is not understood and sends a query (504) to external resources (500). The external resources (500) may be a single resource or multiple resources that include different sets of external information.

The external resources (500) send semantic annotations (506) in response to the query (504) that includes the requested information. Also, the semantic annotations is accompanied with a confidence score (508) that indicates how confident the external resources (500) are about the accuracy of the response. If the external resources' confidence is below a confidence threshold, the external resources continue to search for an answer from other sources until semantic annotations with a higher confidence is found or until a time threshold is reached. In other examples, the semantic annotations (506) are sent regardless of the value of the confidence score (508). In other examples, no confidence score is included with the semantic annotations (506).

In some examples, the semantic annotations (506) are compared to the other extracted data to ensure that the semantic annotations (506) make sense. In examples where the semantic annotations (506) do not make sense in the context of the other extracted data, the external resources (500) may search for additional possible semantic annotations. In other examples, if the external resources find multiple potential semantic annotations, the external resources (500) send each potential semantic annotation back to the consulting engine (502). The consulting engine (502) forwards the semantic annotation to a fact inference engine (600, FIG. 6) to construct a user fact structured object (602, FIG. 6).

FIG. 6 is a diagram of an example of inferring facts according to principles described herein. In this example, the extracted data from the URL object (604), the content object (606), and the external resource semantic annotations (608) are sent to a fact inference engine (600) that uses this information to infer at least one fact about the user. The facts may include the users search intent, the user's likes, a status about the user, a user's recent online activity, a user's location, a user's marital status, a user's educational status, a user's profession, other information about the user, or combinations thereof.

In this example, the user fact structured object (602) is populated with inferred facts from the examples of FIGS. 3 and 4 and semantic annotations from external resources. Here, the inferred facts include 1) the website (610) is a destination travel website, 2) the user activity (612) was booking a trip online, 3) the hotel accommodations (614) for the trip include staying at a hotel referred to as “MV,” 4) the trip accommodations (616) are part of a package, 5) the action's location (618) was at the General Edward Lawrence Logan International Airport (BOS) located in Boston, 6) the destination airport (620) is Newark Liberty International Airport in Newark, N.J. 7) the return airport (622) is BOS, 8) the departure date (624) is May 15, 2012, 9) the return flight date (626) is May 21, 2012, and 10) the room specifications (628) include a queen sized bed. These facts may be used to tailor an action targeted to the user, such as online advertising, making online recommendations, filling in a profile for the user, other actions, or combinations thereof.

FIG. 7 is a diagram of an example of a display (700) according to principles described herein. In this example, a monitor (702) includes a display (700) that includes web page content (704). The monitor (702) is in communication with a fact inference engine (705) that provides inferred facts to the user's processors and allows the inferred facts to be utilized.

The display (700) also includes an advertisement (706) that is targeted to the user based on the facts inferred from the web page from which the user retained at least some of the web page's content. In this example, the inferred facts include that the user booked a flight to Newark, N.J. from Boston, Mass. Thus, in response, the targeted advertisement (706) advertises cheap flights to Newark, N.J.

Also, the display (700) includes a recommendation (708) based on the inferred fact that the user booked a flight from Boston. Thus, the recommendation (708) includes information about using the electronic check-in system at the airport located in Boston.

The fact inference engine (705) is also in communication with a user profile engine (710) that includes information about the user. The user profile engine (710) fills in information about the user based on the inferred facts provided by the fact inference engine (705). The user profile may be a social network profile, a professional profile, a membership profile, another type of profile, or combinations thereof.

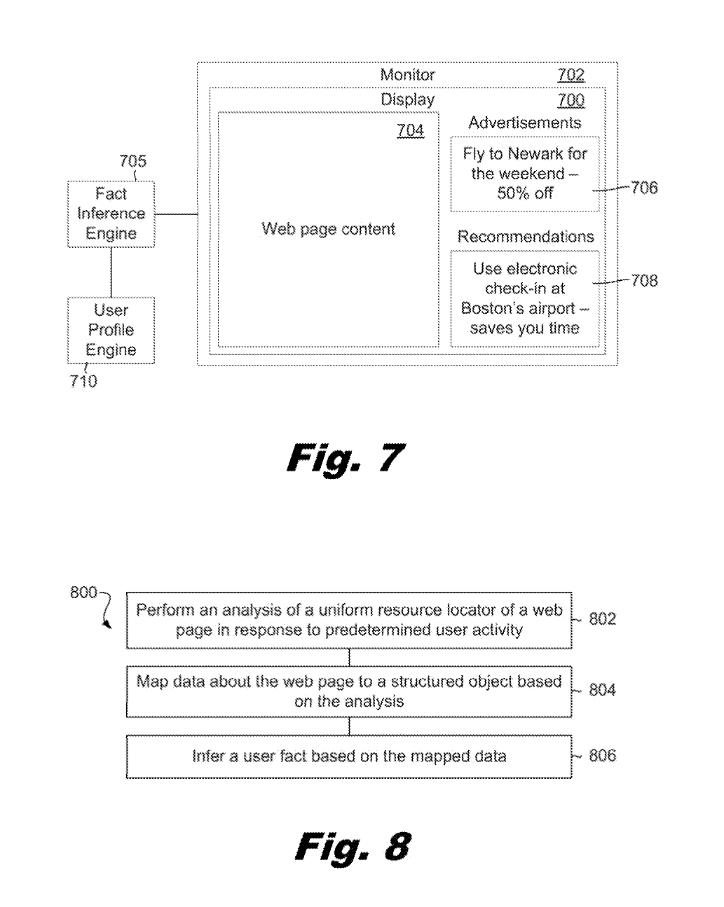

FIG. 8 is a diagram of an example of a method (800) for inferring facts from online user activity according to principles described herein. In this example, the method (800) includes performing (802) an analysis of the URL of a web page in response to predetermined user activity, mapping (804) data about the web page to a structured object based on the analysis, and inferring (806) a fact about the user activity based on the mapped data.

Performing the analysis on the URL may include classifying the web page into web page types based on the information in the URL. Some of the web page types belong to a classification that are to be excluded from further analysis. In such circumstances, the analysis ends in response to determining that the web page belongs to such a classification. These classifications may include email web page types, web page types that likely contain sensitive information, other web page types, or combinations thereof. If the web page type falls outside of such a classification, the analysis may include extracting potentially meaningful information from the URL and the web page's content.

The method may also include querying external resources about a meaning of the mapped data. The answers to the queries may include an accompanying confidence score.

In response to inferring a fact about the user, a program can use the inferred fact. For example, a program may include displaying a user targeted advertisement based on the inferred fact, displaying a user customized recommendation based on the inferred fact, filling out a user profile based on an inferred fact, other mechanisms for using the inferred fact, or combinations thereof.

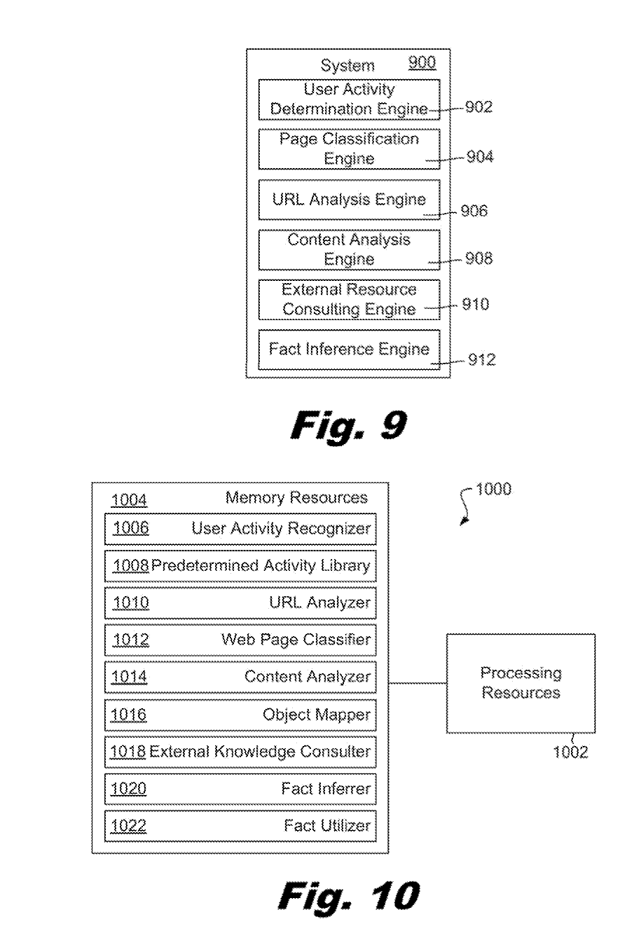

FIG. 9 is a diagram of an example of a system (900) for inferring facts from online user activity according to principles described herein. In this example, the system (900) includes a user activity determination engine (902), a page classification engine (904), an URL analysis engine (906), a content analysis engine (908), an external resource consulting engine (910), and a fact inference engine (912). The engines (902, 904, 906, 908, 910, 912) refer to a combination of hardware and program instructions to perform a designated function. Each of the engines (902, 904, 906, 908, 910, 912) may include a processor and memory. The program instructions are stored in the memory and cause the processor to execute the designated function of the engine.

The user activity determination engine (902) determines when a user performs a predetermined user activity and on which web page the predetermined user activity occurred. The predetermined user activity may include activities, such as clipping, printing, copying, saving, bookmarking, and so forth, where at least a portion of the web page's content is retained by the user.

The page classification engine (904) classifies the web page to determine whether to continue with the analysis. The URL analysis engine (906) analyzes the information in the web page's URL and extracts meaningful information into the URL object. Likewise, the content analysis engine (908) analyzes the information in the web page's content and extracts meaningful information into the content object. In other examples, a single engine analyzes both the URL and the web page's content and puts the extracted information into a single object.

The external resource engine (910) sends queries about extracted information where the extracted information's meaning is unclear. The external resource engine (910) obtains answers about the queried data and sends those answers to the fact inference engine (910). The fact inference engine (910) infers facts about the user. The inferred facts may include the user's search intent, activities performed by the user, the user's location, other facts about the user, or combinations thereof.

FIG. 10 is a diagram of an example of an inference system (1000) according to principles described herein. In this example, the inference system (1000) includes processing resources (1002) that are in communication with memory resources (1004). Processing resources (1002) include at least one processor and other resources used to process programmed instructions. The memory resources (1004) represent generally any memory capable of storing data such as programmed instructions or data structures used by the inference system (1000). The programmed instructions shown stored in the memory resources (1004) include a user activity recognizer (1006), a URL analyzer (1010), a web page classifier (1012), a content analyzer (1014), object mapper (1016), external knowledge consulter (1018), fact inferrer (1020), and fact utilizer (1022). The data structures shown stored in the memory resources (1004) include a predetermined activity library (1008).

The memory resources (1004) include a computer readable storage medium that contains computer readable program code to cause tasks to be executed by the processing resources (1002). The computer readable storage medium may be tangible and/or non-transitory storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The user activity recognizer (1006) represents programmed instructions that, when executed, cause the processing resources (1002) to recognize when a user performs one of the activities included in the predetermined activity library (1008). The predetermined activities of the library (1008) may include those activities that allow the user to retain at least some of the information contained within the web page's content.

The URL analyzer (1010) represents programmed instructions that, when executed, cause the processing resources (1002) to analyze the information in the URL in response to recognizing the predetermined user activity. A web page classifier (1012) represents programmed instructions that, when executed, cause the processing resources (1002) to determine based on the information in the URL whether the web page is of the type that is cleared for further processing. If the web page is cleared for further processing, the URL analyzer (1010) extracts meaningful information from the URL. The content analyzer (1014) represents programmed instructions that, when executed, cause the processing resources (1002) to extract meaningful information from the web page's content. The object mapper (1016) represents programmed instructions that, when executed, cause the processing resources (1002) to map the extracted data to the URL or content objects.

The external knowledge consulter (1018) represents programmed instructions that, when executed, cause the processing resources (1002) to consult with external resources to understand the meaning of the extracted information. The fact inferrer (1020) represents programmed instructions that, when executed, cause the processing resources (1002) to infer facts from the extracted information and the information provided from the external resources. The fact utilizer (1022) represents programmed instructions that, when executed, cause the processing resources (1002) to utilize the inferred facts in some manner, such as for targeting advertisements, customizing recommendations, filling out user profiles, other ways of utilizing the information, or combinations thereof.

Further, the memory resources (1004) may be part of an installation package. In response to installing the installation package, the programmed instructions of the memory resources (1004) may be downloaded from the installation package's source, such as a portable medium, a server, a remote network location, another location, or combinations thereof. Portable memory media that are compatible with the principles described herein include DVDs. CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (1002) and the memory resources (1004) are located within the same physical component, such as a server, or a network component. The memory resources (1004) may be part of the physical component's main memory, caches, registers, non-volatile memory, or elsewhere in the physical component's memory hierarchy. Alternatively, the memory resources (1004) may be in communication with the processing resources (1002) over a network. Further, the data structures, such as the libraries and may be accessed from a remote location over a network connection while the programmed instructions are located locally. Thus, the inference system (1000) may be implemented on a user device, on a server, on a collection of servers, or combinations thereof.

The inference system (1000) of FIG. 10 may be part of a general purpose computer. However, in alternative examples, the inference system (1000) is part of an application specific integrated circuit.

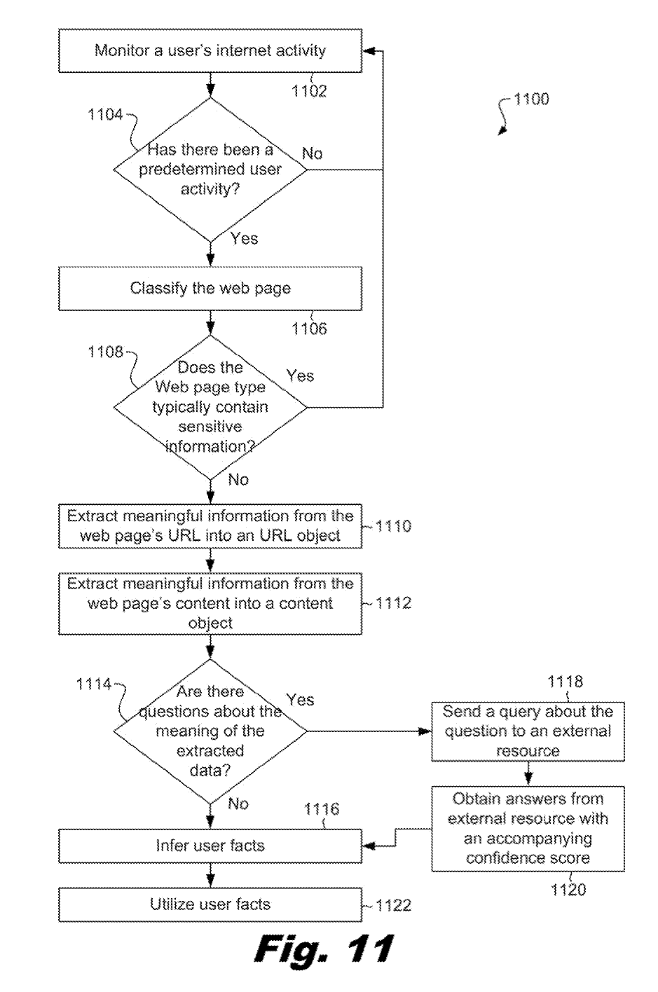

FIG. 11 is a diagram of an example of a flowchart (1100) of a process for inferring facts from online user activity according to principles described herein. In this example, the process includes monitoring (1102) the user's internet activity and determining (1104) whether there has been a predetermined user activity performed by the user. In response to determining that the user has performed some predetermined user activity, the process includes classifying (1106) the web page on which the predetermined user activity occurred and determining (1108) whether the website type usually contains sensitive information. In response to determining that the web page type usually contains sensitive information or is of another type that is not to be further analyzed, the process returns to monitoring (1102) the user's internet activity.

If the web page type is clear for further processing, the process includes extracting (1110) meaningful information from the web page's URL into an URL object and extracting (1112) meaningful information from the web page's content into a content object. The process also includes determining (1114) whether there are questions about the meaning of the extracted data. If the meaning of all of the extracted data is understood, the process includes inferring (1116) facts about the user. If the meaning of at least some of the data is unclear, the process includes sending (1118) a query about the questions to an external resource and obtaining (1120) answers from the external resource with an accompanying confidence score. These answers are used when inferring (1116) facts about the user. After the facts are inferred (1116), the process includes utilizing (1122) the user facts.

While the examples above have been described with reference to specific types of web page classifications, any appropriate web page classification types for determining whether to continue with the web page's analysis may be used in accordance with the principles described herein. Further, while the examples above have been described with reference to specific types of predetermined activity, any appropriate type of predetermined activity, especially predetermined activity that has a significantly greater probability of revealing facts about a user than merely clicking on a website may be used in accordance with the principles described herein.

Further, while the examples above have been described with reference to specific ways of identifying meaningful information from both the URL and the web page's content, any appropriate mechanism for identifying meaningful information may be used according to the principles described herein. Also, while the URL and content objects have been described with reference to specific formats, information, and structures, any appropriate format, information, or structure in accordance with the principles described herein may be used.

Also, while the examples above have been described with reference to specific ways of obtaining outside information to give meaning to at least some of the extracted information, any appropriate mechanism for obtaining external information may be used in accordance with the principles described herein. Further, while the examples above have been described with reference to specific types of inferred facts about the user, any appropriate type of fact may be inferred about the user.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for inferring facts from online user activity, comprising:
performing an analysis of a uniform resource locator of a web page in response to predetermined user activity;
mapping data about said web page to a structured object based on said analysis; and
inferring a user fact based on said mapped data.

2. The method of claim 1, wherein predetermined user activity includes printing content from said web page, saving content from said web page, copying content from said web page, bookmarking said web page, clipping content from said web page, or combinations thereof.

3. The method of claim 1, wherein said user fact includes a user's likes, a user's action, a user's status, a user's location, or combinations thereof.

4. The method of claim 1, further comprising displaying user targeted advertisements based on said user fact.

5. The method of claim 1, further comprising filling out a user profile based on said user fact.

6. The method of claim 1, further displaying a user customized recommendation based on said user fact.

7. The method of claim 1, wherein performing said analysis of said uniform resource locator of said web page in response to predetermined user activity includes classifying said web page into web page types based on said uniform resource locator.

8. The method of claim 7, wherein classifying said web page into web page types based on said uniform resource locator includes determining whether said web page belongs to a classification to be excluded from further analysis.

9. The method of claim 1, wherein mapping data from said web page to said structured object based on said analysis includes extracting meaningful information from said uniform resource locator and content of said web page to said structured object.

10. The method of claim 1, further comprising querying external resources about a meaning of said mapped data.

11. The method of claim 10, wherein querying external resources about said meaning of said mapped data includes obtaining an answer from said external resources with an accompanying confidence score.

12. A system for inferring facts from online user activity, comprising:
a user activity determination engine to recognize a predetermined user activity on a web page;
a uniform resource locator analysis engine to analyze a uniform resource locator in response to recognizing said predetermined user activity;
a content analysis engine to analyze content of said web page in response to said uniform resource locator analysis; and
fact inference engine to infer a user fact based results of said uniform resource locator engine and content engine.

13. The system of claim 12, further comprising querying external resources about data in said uniform resource locator and said content.

14. A computer program product for inferring facts from online user activity, comprising:
a tangible computer readable storage medium, said tangible computer readable storage medium comprising computer readable program code embodied therewith, said computer readable program code comprising program instructions that, when executed, causes a processor to;
perform an analysis of a uniform resource locator of a web page and of content in said web page in response to retention user activity;
map data about said web page to a structured object based on said analysis;
infer a user fact based on said mapped data; and
utilize said inferred fact in a user specific activity.

15. The computer program product of claim 14, wherein said user specific activity includes displaying user targeted advertisements based on said user fact, filling out a user profile based on said user fact, displaying a user tailored recommendation based on said user fact.
